(19) United States
(12) Patent Application Publication
(10) Pub. No.: US 2010/0263464 A1
(43) Pub. Date: Oct. 21, 2010

(54) Operating Mechanism and Operating Device Using the Same

(75) Inventor: Jung-Chi Lai, Guishan Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan Shien (TW)

(21) Appl. No.: 12/761,130

(22) Filed: Apr. 15, 2010

(30) Foreign Application Priority Data
Apr. 20, 2009 (TW) 98206577

(51) Int. Cl. F16H 21/12

(52) U.S. Cl. 74/63

(57) ABSTRACT

An operating mechanism including a driven member and an actuating member is provided. The actuating member includes a shaft. The radial outer wall of the shaft contacts with that of the driven member. The shaft is used for rotating around a first axis so as to drive the driven member to rotate around a second axis. The second axis is substantially parallel to the first axis, and the rotating direction of the driven member is opposite to that of the shaft.

This application claims the benefit of Taiwan application Serial No. 98206577, filed Apr. 20, 2009, the subject matter of which is incorporated herein by reference.

### BACKGROUND OF THE INVENTION

1. Field of the Invention

The invention relates in general to an operating mechanism and an operating device using the same, and more particularly to an operating mechanism with low loads and high degrees of freedom and an operating device using the same.

2. Description of the Related Art

Along with the development of automation technology, the design of mechanisms is getting more and more diversified. In the design of a mechanism, the degrees of freedom are decided based on the needs of the movement of the mechanism. In general, the mechanism is driven through a driving component, such as a motor, incorporated with a gear set so as to increase the flexibility in application.

The way of driving the mechanism through the incorporation of the motor and the gear set can usually only enable the mechanism to move in a single axial direction. Although the mechanism can be driven to move in several axial directions through the stack motors, the stack motors would cause a great load to the motor driving the base shaft. Thus, how to provide a mechanism which increases the degrees of freedom and avoids the driving component being overloaded has become a prominent task for the industries.

### SUMMARY OF THE INVENTION

The invention is directed to an operating mechanism and an operating device using the same. Through mutual contact, the relative movement is performed between the actuating member and the driven member so as to effectively avoid the actuating member being overloaded.

According to a first aspect of the present invention, an operating mechanism including a driven member and a first actuating member is provided. The first actuating member includes a first shaft. The radial outer wall of the first shaft contacts with the radial outer wall of the driven member. The first shaft is used for rotating around a first axis so as to drive the driven member to rotate around a second axis. The second axis is substantially parallel to the first axis, and the rotating direction of the driven member is opposite to the rotating direction of the first shaft.

According to a second aspect of the present invention, an operating device including a base and an operating mechanism is provided. The base has a tank. The operating mechanism is received in the tank. The operating mechanism includes a driven member and a first actuating member. The first actuating member includes a first shaft. The radial outer wall of the first shaft contacts with radial outer wall of the driven member. The first shaft is used for rotating around a first axis so as to drive the driven member to rotate around a second axis with respect to the base. The second axis is substantially parallel to the first axis, and the rotating direction of the driven member is opposite to the rotating direction of the first shaft.

The invention will become apparent from the following detailed description of the preferred but non-limiting embodiments. The following description is made with reference to the accompanying drawings.

### BRIEF DESCRIPTION OF THE DRAWINGS

FIG. 1A shows a three-dimensional diagram of an operating mechanism according to a first embodiment of the present invention.

FIG. 1B shows a side view of the operating mechanism in FIG. 1A.

FIG. 2A and FIG. 2B show the driven member being rotated to different positions.

FIG. 3 shows the ring portion in FIG. 1A driving the first actuating member to rotate.

FIG. 4 shows another shaft and driven member.

FIG. 5 shows a cross-sectional view of the operating mechanism taken along line 5-5′ in FIG. 1A.

FIG. 6 shows an operating device according to a second embodiment of the present invention.

### DETAILED DESCRIPTION OF THE INVENTION

The present invention mainly provides an operating mechanism and an operating device using the same. The operating mechanism includes a driven member and an actuating member. The actuating member includes a shaft. The radial outer wall of the shaft contacts with the radial outer wall of the driven member. The shaft is used for rotating around a first axis so as to drive the driven member to rotate around a second axis. The second axis is substantially parallel to the first axis, and the rotating direction of the driven member is opposite to the rotating direction of the shaft.

A number of preferred embodiments are disclosed below with the accompanying drawings for detailed description of the operating mechanism and the operating mechanism using the same according to the present invention. However, a person having ordinary skills in the art should understand that the disclosure and the drawings are for detailed description of the present invention, but not for limiting the scope of protection of the present invention.

### First Embodiment

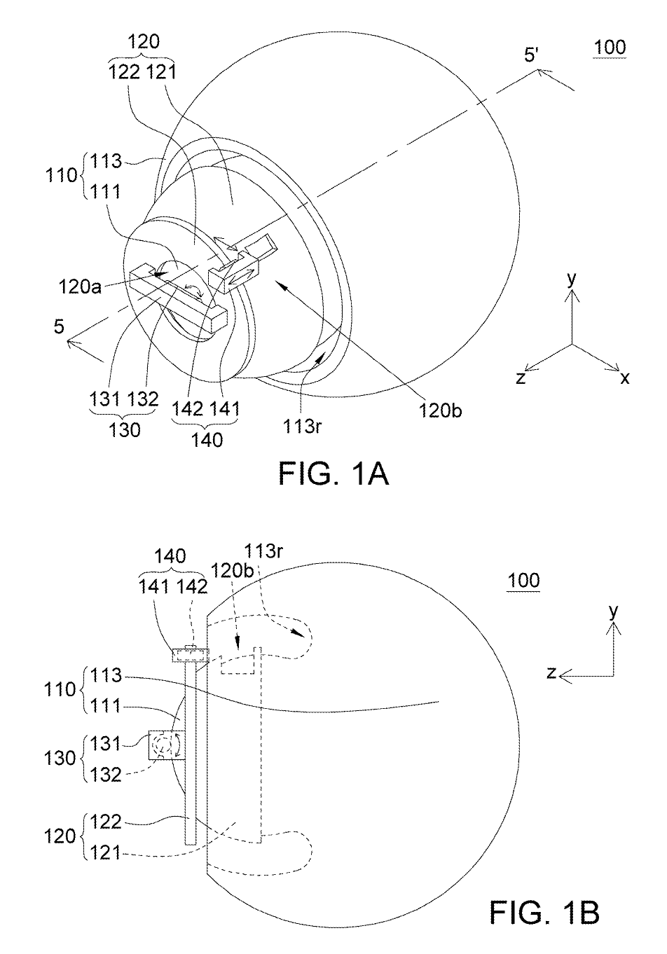

Referring to both FIG. 1A and FIG. 1B, a three-dimensional diagram of an operating mechanism according to a first embodiment of the present invention is shown in FIG. 1A, and a side view of the operating mechanism in FIG. 1A is shown in FIG. 1B.

The operating mechanism 100 includes a driven member 110, a sleeve member 120 and a first actuating member 130. The driven member 110 has a spherical portion 111 and an exposing portion 113. The exposing portion 113 has a recess 113r. The spherical portion 111 is connected to the inner wall of the recess 113r. A space between the spherical portion 111 and the inner wall of the recess 113r is used for receiving the sleeve member 120 and the first actuating member 130.

The first actuating member 130 includes a body 131 and a shaft 132. The shaft 132 is pivotally connected to the body 131. The spherical portion 111 of the driven member 110 is rotatably disposed in the sleeve member 120, and the body 131 is fixed to the sleeve member 120.

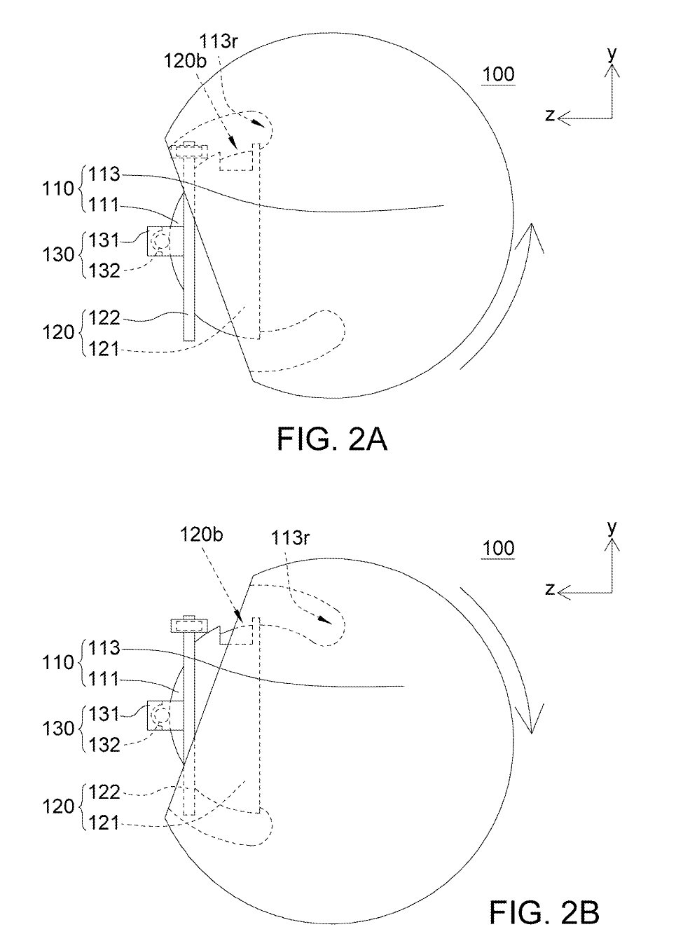

The sleeve member 120 has a through hole 120a. The radial outer wall of the shaft 132 contacts with the radial outer wall of the driven member 110 through the through hole 120a. In the present embodiment of the invention, the shaft 132 is used for rotating around an axis parallel to the x-axis, so that the driven member 110 is driven to rotate around another axis parallel to the x-axis through the friction. The rotating direction of the driven member 110 is opposite to the rotating direction of the shaft 132. For example, if the shaft 132 rotates clockwise, the driven member 110 rotates anti-clockwise as indicated in FIG. 2A. Or, if the shaft 132 rotates anti-clockwise, the driven member 110 rotates clockwise as indicated in FIG. 2B.

As indicated in FIG. 1A and FIG. 1B, in order to further increase the degrees of freedom of the driven member 110 during rotation, the sleeve member 120 further includes a receiving portion 121 and a ring portion 122, and the ring portion 122 has a through hole 120a. The ring portion 122 is rotatably coupled to the receiving portion 121. The spherical portion 111 of the driven member 110 is rotatably disposed in the receiving portion 121, and the body 131 is fixed to the ring portion 122. Thus, when the ring portion 122 rotates, the first actuating member 130 is driven to rotate with respect to the receiving portion 121, so that the shaft 132 is capable of rotating around different axes.

In the present embodiment of the invention, the operating mechanism 100 further includes a second actuating member 140 which drives the ring portion 122 to rotate with respect to the receiving portion 121. The second actuating member 140 includes a body 141 and a shaft 142. The shaft 142 is pivotally connected to the body 141. The radial outer wall of the shaft 142 is used for contacting with the radial outer wall of the ring portion 122 and rotating around an axis parallel to the z-axis, so that the ring portion 122 is driven to rotate around another axis parallel to the z-axis. The rotating direction of the ring portion 122 is opposite to the rotating direction of the shaft 142, and neither the axis of the shaft 142 nor the axis of the ring portion 122 is parallel to the axis of the shaft 132.

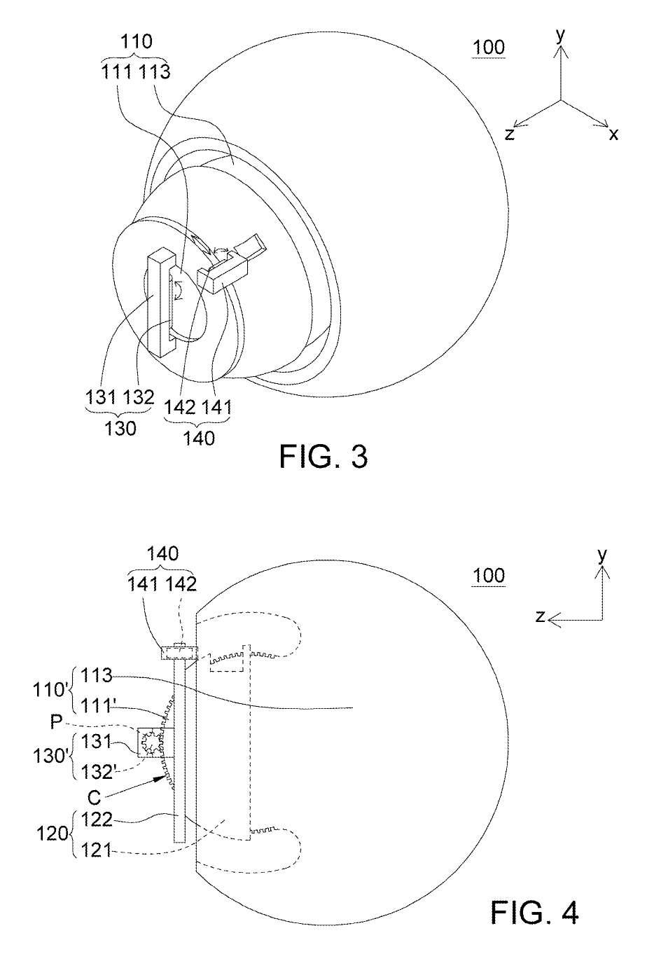

An example is disclosed below for detailed description of how the second actuating member 140 drives the ring portion 122 to rotate. As indicated in FIG. 1A, the axis of the shaft 132 of the first actuating member 130 is parallel to the x-axis. When the shaft 142 of the second actuating member 140 drives the ring portion 122 to rotate with respect to the receiving portion 121 to a position indicated in FIG. 3, the first actuating member 130 fixed to the ring portion 122 rotates correspondingly for enabling the axis of the shaft 132 to change from a direction parallel to the x-axis to a direction parallel to the y-axis. At this time, when the shaft 132 rotates, the driven member 110 is driven to rotate around another axis parallel to the y-axis. Trough the disposition and design of the sleeve member 120 and the second actuating member 140, the degrees of freedom of the driven member 110 during rotation can be increased so as to increase the operation flexibility of the operating mechanism 100.

To assure that the spherical portion 111 of the driven member 110 can rotate smoothly in the receiving portion 121 of the sleeve member 120, the outline shape of the inner wall of the receiving portion 121 is preferably spherical according to the movement of the spherical portion 111.

Besides, the second actuating member 140 can be moveably disposed on one side of the sleeve member 120, so that the radial outer wall of the shaft 142 can selectively contact with the ring portion 122 or the driven member 110. When the position of the second actuating member 140 enables the shaft 142 to directly contact with the ring portion 122, the shaft 142 is used for driving the ring portion 122 to change the axial direction of the shaft 132. Such movement mechanism is disclosed above and is not repeatedly described herein. When the position of the second actuating member 140 enables the shaft 142 to directly contact with the driven member 110, the shaft 142 is used for driving the driven member 110. More specifically, when the radial outer wall of the shaft 142 directly contacts with the radial outer wall of the driven member 110 and the shaft 142 rotates, the driven member 110 is driven to rotate, and the rotating direction of the driven member 110 is opposite to the rotating direction of the shaft 142. Thus, the degrees of freedom of the driven member 110 during rotation are further increased.

In the present embodiment of the invention, the shaft 142 can contact with the driven member 110 through a gap 120b (illustrated in FIG. 1A) of the sleeve member 120. Or, through the second actuating member 140, the shaft 142 can directly be moved to the part of the driven member 110 which is not covered by the receiving portion 121 for contacting with the driven member 110.

The radial outer wall of the driven member 110 and the radial outer wall of the shaft 132 both have smooth surfaces in the above exemplification. However, the outline shape of the radial outer wall of the driven member 110 and that of the shaft 132 can be designed to match with each other in shape for increasing the friction, so that the rotation capability is increased. Referring to FIG. 4, another shaft and driven member is shown. The radial outer wall of the shaft 132′ of the first actuating member 130′ has several protrusions P, and the radial outer wall of the spherical portion 111′ of the driven member 110′ has several concaves C. When the shaft 132′ drives the spherical portion 111′ to rotate, a portion of the protrusion P is received in the concave C, so that the relative movement between the shaft 132′ and the spherical portion 111′ is improved in a way similar to coupling. Or, the protrusions P can be located at the radial outer wall of the spherical portion 111′, and the concaves C can be located at the radial outer wall of the shaft 132′. Moreover, the outer wall of the shaft 142 and that of the ring portion 122 can be designed to match with each other, so that the friction is increased to enhance the rotation capability.

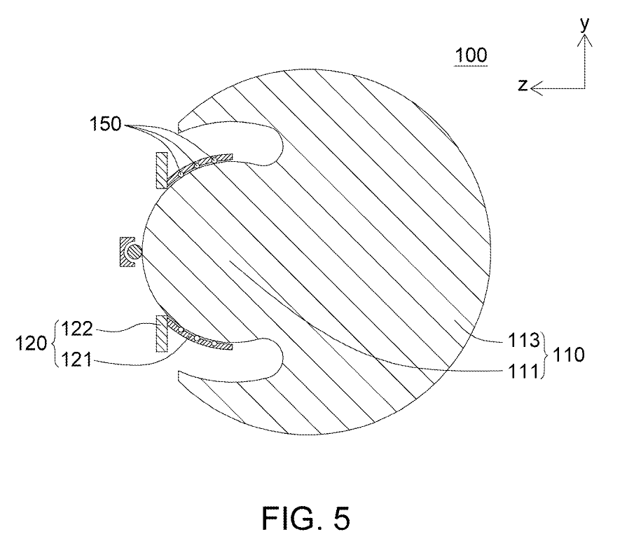

Referring to FIG. 5, a cross-sectional view of the operating mechanism taken along line 5-5′ in FIG. 1A is shown. The operating mechanism 100 can further includes several balls 150 disposed between the receiving portion 121 of the sleeve member 120 and the spherical portion 111 of the driven member 110. Therefore, the friction generated when the receiving portion 121 and the spherical portion 111 contact with each other can be reduced to make the spherical portion 111 smoothly rotate with respect to the receiving portion 121. In the present embodiment of the invention, a portion of each ball 150 is embedded into the receiving portion 121, and the other portion of each ball 150 is used for contacting with the spherical portion 111. Or, a portion of each ball 150 can be embedded into the spherical portion 111, and the other portion of each ball 150 is used for contacting with the receiving portion 121 for reducing the friction generated when the receiving portion 121 and the spherical portion 111 contact with each other.

### Second Embodiment

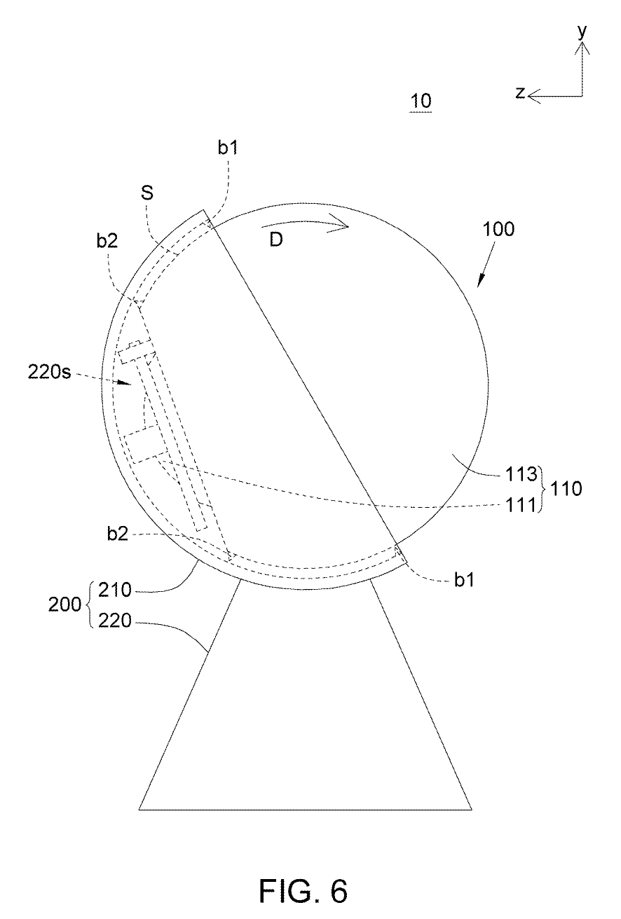

Referring to FIG. 6, an operating device according to a second embodiment of the present invention is shown. The operating device 10 includes the operating mechanism 100 illustrated in the first embodiment and a base 200. As the operating mechanism 100 is disclosed in the first embodiment, only the structure of the base 200 and its disposition with respect to the operating mechanism 100 are further disclosed below.

The base 200 includes an upper portion 210 and a lower portion 220. The upper portion 210 and the lower portion 220 can be integrally formed. A tank 220s of the base 200 is located at the upper portion 210. The operating mechanism 100 is received in the tank 220s in a way of only exposing the exposing portion 113 of the driven member 110, hence improving the appearance of the device.

In addition, the rotation stroke of the driven member 110 with respect to the base 200 is defined through the disposition of blocking portions. The tank 220s has two blocking portions b1 located on the inner wall of the tank 220s. The driven member 110 has two blocking portions b2 located on the outer surface S of the exposing portion 113. The blocking portion b1 is used for limiting the movement of the driven member 110 when leaning against the blocking portion b2. For example, when the driven member 110 is driven to rotate with respect to the base 200 in a direction D, and the blocking portion b1 leans against the blocking portion b2, the driven member 110 can not keep rotating in the direction D. Therefore, the rotation stroke of the driven member 110 with respect to the base 200 is defined. However, the positions of the blocking portions b1 and b2 in FIG. 6 are merely an example, and the positions of the blocking portions b1 and b2 can be determined according to the desired rotation stroke of the driven member 110.

Moreover, to assure that the operating mechanism 100 can move smoothly in the base 200, the outline shape of the outer wall of the exposing portion 113 is substantially identical to that of the inner wall of the tank 220s. Preferably, both the outline shape of the exposing portion 113 the outline shape of the inner wall of the tank 220s are spherical so as to match the movement of the driven member 110 with respect to the base 200.

According to the operating mechanism and the operating mechanism using the same disclosed in the above embodiments of the invention, the shaft of the first actuating member contacts with the driven member to drive the driven member to rotate accordingly. The disposition of the sleeve member and that of the second actuating member further increase the degrees of freedom of the driven member. In addition, since the first actuating member and the second actuating member move independently, the overloading situation that occurs to the conventional design of the stack motors can be avoided.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operating mechanism, comprising:
a driven member; and
a first actuating member comprising a first shaft, wherein the radial outer wall of the first shaft contacts with the radial outer wall of the driven member, the first shaft is used for rotating around a first axis so as to drive the driven member to rotate around a second axis, the second axis is substantially parallel to the first axis, and the rotating direction of the driven member is opposite to the rotating direction of the first shaft.

2. The operating mechanism according to claim 1, wherein the first actuating member further comprises a body, the first shaft is pivotally connected to the body, and the operating mechanism further comprises:
a sleeve member, wherein the driven member is rotatably disposed in the sleeve member, the body is fixed to the sleeve member, the sleeve member has a through hole, and the radial outer wall of the first shaft contacts with the radial outer wall of the driven member through the through hole.

3. The operating mechanism according to claim 2, wherein the sleeve member comprises:
a receiving portion, wherein the driven member is rotatably disposed in the receiving portion; and
a ring portion rotatably coupled to the receiving portion, wherein the body is fixed to the ring portion, and the ring portion has the through hole and is used for driving the first actuating member to rotate with respect to the receiving portion.

4. The operating mechanism according to claim 3, further comprising:
a second actuating member comprising a second shaft, wherein the radial outer wall of the second shaft is used for contacting with the radial outer wall of the ring portion, the second shaft is used for rotating around a third axis so as to drive the ring portion to rotate around a fourth axis, the fourth axis is substantially parallel to the third axis, the third axis is not parallel to the first axis, and the rotating direction of the ring portion is opposite to the rotating direction of the second shaft.

5. The operating mechanism according to claim 4, wherein the second actuating member is moveably disposed on one side of the sleeve member, so that the radial outer wall of the second shaft is further used for contacting with the radial outer wall of the driven member, the second shaft is further used for driving the driven member to rotate around the fourth axis, and the rotating direction of the driven member is opposite to the rotating direction of the second shaft.

6. The operating mechanism according to claim 5, wherein the sleeve member has a gap, and the second shaft contacts with the driven member through the gap.

7. The operating mechanism according to claim 2, further comprising:
a plurality of balls disposed between the sleeve member and the driven member.

8. The operating mechanism according to claim 7, wherein a portion of each ball is embedded into one of the sleeve member and the driven member, and the other portion of each ball is used for contacting with the other one of the sleeve member and the driven member.

9. The operating mechanism according to claim 2, wherein the driven member has a spherical portion and an exposing portion, the exposing portion has a recess, the spherical portion is connected to the inner wall of the recess and is rotatably disposed in the sleeve member, and a space between the spherical portion and the inner wall of the recess is used for receiving the sleeve member and the first actuating member.

10. The operating mechanism according to claim 9, wherein the outline shape of the inner wall of the sleeve member is spherical.

11. The operating mechanism according to claim 9, wherein the driven member further has at least one blocking portion located on the outer surface of the exposing portion for limiting the movement of the driven member when the blocking portion leans against an object.

12. The operating mechanism according to claim 1, wherein the radial outer wall of one of the first shaft and the driven member has a plurality of protrusions, the radial outer wall of the other one of the first shaft and the driven member has a plurality of concaves, and each concave is used for receiving a portion of one of the protrusions.

13. An operating device, comprising:
a base having a tank; and
an operating mechanism received in the tank, wherein the operating mechanism comprises:
a driven member; and
a first actuating member comprising a first shaft, wherein the radial outer wall of the first shaft contacts with the radial outer wall of the driven member, the first shaft is used for rotating around a first axis so as to drive the driven member to rotate around a second axis with respect to the base, the second axis is substantially parallel to the first axis, and the rotating direction of the driven member is opposite to the rotating direction of the first shaft.

14. The operating device according to claim 13, wherein the first actuating member further comprises a body, the first shaft is pivotally connected to the body, and the operating mechanism further comprises:
a sleeve member, wherein the driven member is rotatably disposed in the sleeve member, the body is fixed to the sleeve member, the sleeve member has a through hole, and the radial outer wall of the first shaft contacts with the radial outer wall of the driven member through the through hole.

15. The operating device according to claim 14, wherein the sleeve member comprises:
a receiving portion, wherein the driven member is rotatably disposed in the receiving portion; and
a ring portion rotatably coupled to the receiving portion, wherein the body is fixed to the ring portion, and the ring portion has the through hole and is used for driving the first actuating member to rotate with respect to the receiving portion.

16. The operating device according to claim 15, wherein the operating mechanism further comprises:
a second actuating member comprising a second shaft, wherein the radial outer wall of the second shaft is used for contacting with the radial outer wall of the ring portion, the second shaft is used for rotating around a third axis so as to drive the ring portion to rotate around a fourth axis, the fourth axis is substantially parallel to the third axis, the third axis is not parallel to the first axis, and the rotating direction of the ring portion is opposite to the rotating direction of the second shaft.

17. The operating device according to claim 16, wherein the second actuating member is moveably disposed on one side of the sleeve member, so that the radial outer wall of the second shaft is further used for contacting with the radial outer wall of the driven member, the second shaft is further used for driving the driven member to rotate around the fourth axis, and the rotating direction of the driven member is opposite to the rotating direction of the second shaft.

18. The operating device according to claim 17, wherein the sleeve member has a gap, and the second shaft contacts with the driven member through the gap.

19. The operating device according to claim 14, wherein the operating mechanism further comprises:
a plurality of balls disposed between the sleeve member and the driven member.

20. The operating device according to claim 19, wherein a portion of each ball is embedded into one of the sleeve member and the driven member, and the other portion of each ball is used for contacting with the other one of the sleeve member and the driven member.

21. The operating device according to claim 14, wherein the driven member has a spherical portion and an exposing portion, the exposing portion has a recess, the spherical portion is connected to the inner wall of the recess and is rotatably disposed in the sleeve member, and a space between the spherical portion and the inner wall of the recess is used for receiving the sleeve member and the first actuating member.

22. The operating device according to claim 21, wherein the outline shape of the inner wall of the sleeve member is spherical.

23. The operating device according to claim 21, wherein the tank has at least one first blocking portion located on the inner wall of the tank, the driven member further has at least one second blocking portion located on the outer surface of the exposing portion, and the at least one first blocking portion is used for limiting the movement of the driven member when the at least one first blocking portion leans against the at least one second blocking portion.

24. The operating device according to claim 21, wherein the outline shape of the outer wall of the exposing portion is substantially identical to the outline shape of the inner wall of the tank.

25. The operating device according to claim 24, wherein both the outline shape of the exposing portion and the outline shape of the inner wall of the tank are spherical.

26. The operating device according to claim 13, wherein the radial outer wall of one of the first shaft and the driven member has a plurality of protrusions, the radial outer wall of the other one of the first shaft and the driven member has a plurality of concaves, and each concave is used for receiving a portion of one of the protrusions.

27. The operating device according to claim 13, wherein the base comprises an upper portion and a lower portion, the tank is located at the upper portion, and the upper portion and the lower portion are integrally formed.
